(19) United States
(12) Patent Application Publication
(10) Pub. No.: US 2007/0288259 A1
(43) Pub. Date: Dec. 13, 2007

(54) Personalized printing technique of any book or content, with the identification of the reader and the publishing company

(76) Inventor: Moshe Ilan Lahat, Sao Paulo (BR)

Correspondence Address: Coral Ridge Enterprises Inc, P.O. Box 771944, Coral Springs, FL, 33077-1944, US

(21) Appl. No.: 11/805,348

(22) Filed: May 23, 2007

(30) Foreign Application Priority Data
May 29, 2006 (BR) PI 0603162

(51) Int. Cl. G06Q 30/00

(52) U.S. Cl. 705/1

(57) ABSTRACT

The present Invention is related to the Personalized Printing Technique of Any Book or Content, With the Identification of the Reader and the Publishing Company, (1), is characterized as being constituted of the printing (2) of some content (3) from a book or digital media, overlapped to the registered data (4) of a user (5), computer's IP address from where the reader accesses the system, date, hour (6), publishing company's logo and/or other items (7) in undertone. In order to produce this type of printing in a simultaneous way, the user (5), via internet or intranet (8), accesses the system through a covenant and/or directly (9) in addition to his/her registered data (4), which are identified with the name, identity registration number, social security number (or other ID), computer's IP address from where the reader accesses the system, date, hour (6), which are stored in a database (10) in order to formalize the printing requisition (11) of the content (3) from a book or digital media. This content (3) from books or from a digitalized media, stored in a proper database (12) is loaded in a page (13) in the system's memory, and at the same time, the database (10), with the registered data (4) from the user (5) and the others (publishing company and computer), transcribes the data in another page (14) in the system's memory so that in the sequence, they are to be merged through a programme, “software”, integrating then the content (3) with the registered data (4) in undertone, to result, in one sole stage, a unique document (15), with the personal data from the user (5) and others (publishing company and computer) in undertone like a watermark at the bottom of the document (15) and over this watermark, the book content (3).

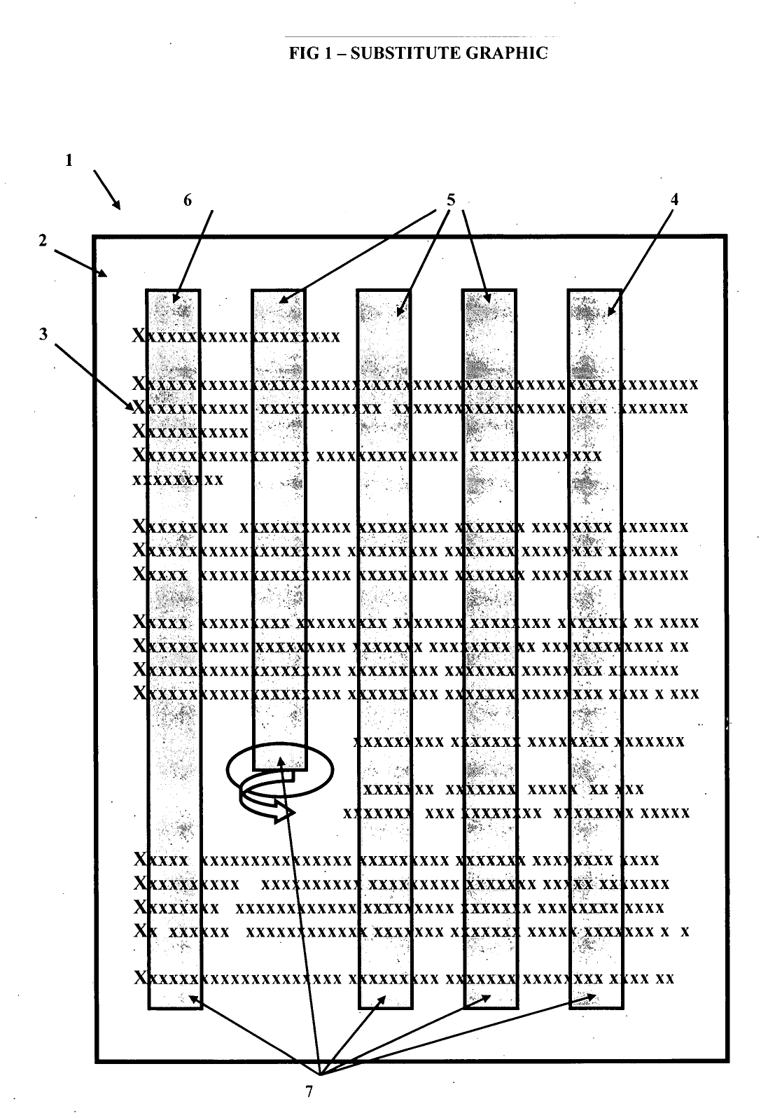

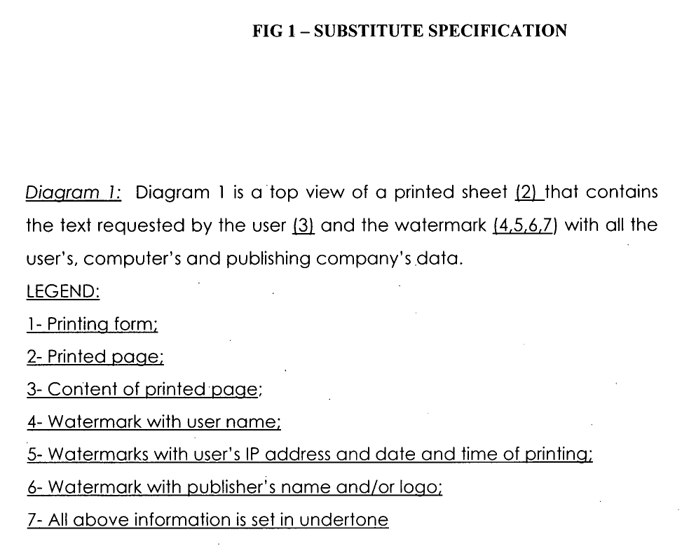

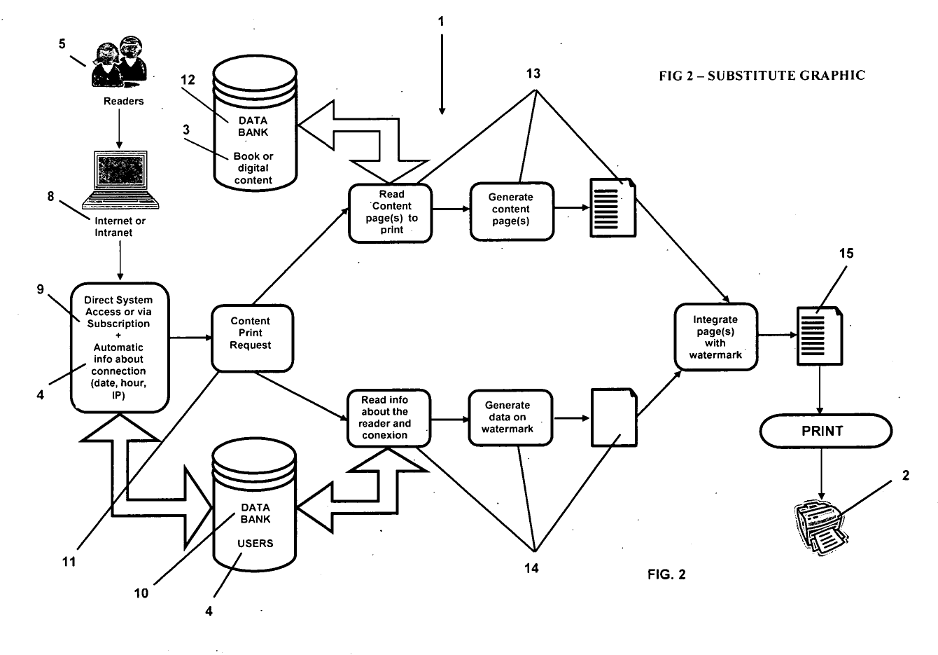

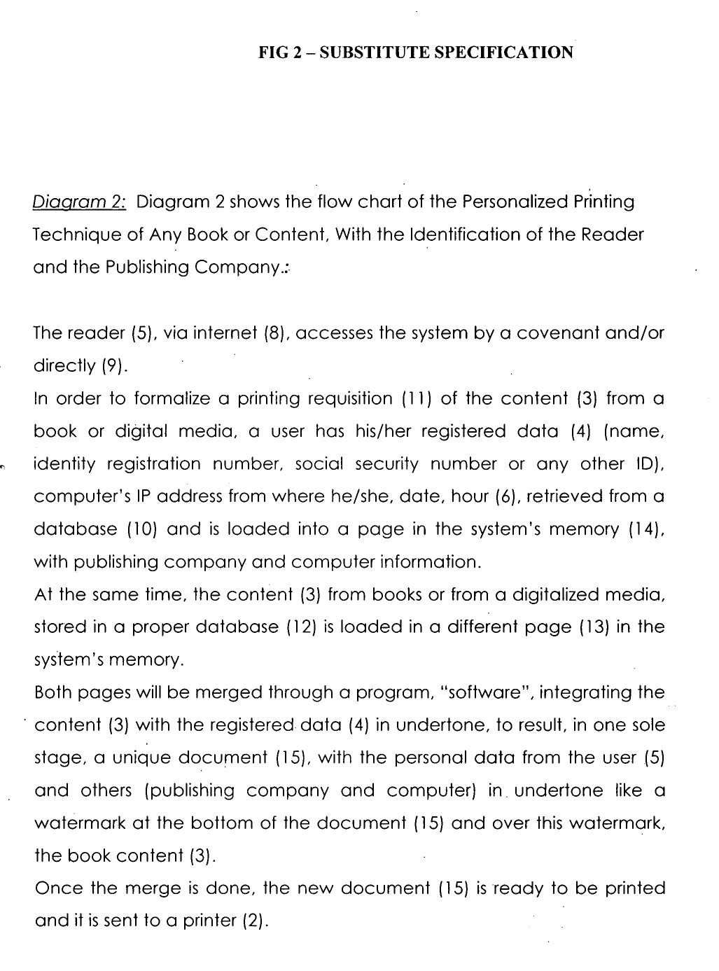

### 1. INTRODUCTION

The present descriptive invention patent report concerns the Personalized Printing Technique of Any Book or Content, With the Identification of the Reader and the Publishing Company, which is characterized as being constituted by the remote printing, via internet or intranet, of a text from a book or digital content, overlapped to the reader's identification data or information such as name, identity number, computer's IP address from where the reader accesses the system, date, hour, publishing company's logo and the material's copyright, being these items may be placed above the text, on a vertical, horizontal or diagonal position on the sheet, in undertone, namely watermark, in such a way that the process will not allow the document's transformation into a printing source for text replication or distribution without proper identification.

Moreover, it is worth stating that the user, referring to the public in general, who creates a registration and login at the first accessing time or who has already been registered by some institution, publishing house or companies alike.

Furthermore, it is also important to mention that this undertone printing technique, called watermark, which has the reader's and the publishing company's individual data, simultaneously with the book's or content's page when printing, is summarized in registering the user, in a page in the publishing company's system database for later, when someone requests the printing of the book content, the two pages are combined through a programme or software, so that at an unique stage, the pages are sent to the printer, resulting on the requested printing material with the additional personal information, as the later had always been part of the book's or content's page.

### 2. APPLICATION FIELD

The application field of this Personalized Printing Technique of Any Book or Content, With the Identification of the Reader and the Publishing Company has its use related to the reprinting of any copyright protected book or content part.

### 3. PURPOSE

The purpose of this Personalized Printing Technique of Any Book or Content, With the Identification of the Reader and the Publishing Company is, as it namely states, to be used as a tool to avoid that any user prints any content of a book and transforms this content into a printing source for reproduction without any prior consent.

### 4. STATE OF TECHNIQUE

In the state of technique, and as it is widely known among publishing companies and institutions that are responsible for protecting copyrights of writers and other professionals, the techniques used to protect and preserve copyright materials are many, nevertheless, most of these protective devices are being hacked, circumvented, especially by very skilful teenagers with computing expertise who transform the devices into ineffective tools to protect any type of contents.

Furthermore, it is vital to state that the theme of technology has caused an enormous uneasiness among jurists, legislators, lawyers, producers, engineers and technicians responsible for securing copyright protected material, entrepreneurs, not for another reason but for the already known difference between the quick changing of techniques and the sluggish like rhythm of the present legislation.

Moreover, it is also important to mention that there is a system that has been implemented in libraries, which through the Digital Items Lending System; it is possible to manage the lending and returning processes, guaranteeing the integrity and the authoring rights of the accessed information.

The mentioned system is based in Client/Server network architecture, which disposes in its core, of a set of procedures for data protection with the use of cryptography and user identification, so that only through the client system, it is possible to be granted access to all services offered by the library. This access is therefore personalized, and it carries the user's identification and the mechanisms to control deadlines for use, unauthorized copies and data integrity.

### 5. TECHNOLOGICAL ADVANCEMENT

Aiming at the solution for the problems stated in the previous section, as well as to offer adequate alternative techniques, the Personalized Printing Technique of Any Book or Content, With the Identification of the Reader and the Publishing Company has been created to implement a process through which the technological advancements establishes:
The use of a low cost technique, which is effective in its purposes, for printing two pages automatically and simultaneously so that in one of them the user's and publishing company's data will be reproduced in undertone and at the other, overlapped on the first, the text of the context requested by the user.
The use of a technique for reproducing any book or content page with all rights reserved, without the possibility of transforming such reproduced material in printing source, once this reproduction will have a watermark with all the user's, computer's and publishing company's data.

### 6. DIAGRAM'S DESCRIPTION

In order to get a complete and overall visualisation of how this Personalized Printing Technique of Any Book or Content, With the Identification of the Reader and the Publishing Company works, there are two explanative diagrams attached to this Invention Patent Report, as described below:

Diagram 1: Diagram 1 is a top view of a printed sheet that contains the text requested by the user and the watermark with all the user's, computer's and publishing company's data.

Diagram 2: Diagram 2 shows the flow chart of the Personalized Printing Technique of Any Book or Content, With the Identification of the Reader and the Publishing Company.

### 7. INVENTION DESCRIPTION

According to what may be inferred from the attached diagrams, the Personalized Printing Technique of Any Book or Content, With the Identification of the Reader and the Publishing Company, (1), is characterized as being constituted of the printing (2) of some content (3) from a book or digital media, overlapped to the registered data (4) of a user (5), computer's IP address from where the reader accesses the system, date, hour (6), publishing company's logo and/or other items (7) in undertone.

In order to produce this type of printing in a simultaneous way, the user (5), via internet or intranet (8), accesses the system through a covenant and/or directly (9) in addition to his/her registered data (4), which are identified with the name, identity registration number, social security number (or other ID), computer's IP address from where the reader accesses the system, date, hour (6), which are stored in a database (10) in order to formalize the printing requisition (11) of the content (3) from a book or digital media.

This content (3) from books or from a digitalized media, stored in a proper database (12) is loaded in a page (13) in the system's memory, and at the same time, the database (10), with the registered data (4) from the user (5) and the others (publishing company and computer), transcribes the data in another page (14) in the system's memory so that in the sequence, they are to be merged through a programme, “software”, integrating then the content (3) with the registered data (4) in undertone, to result, in one sole stage, a unique document (15), with the personal data from the user (5) and others (publishing company and computer) in undertone like a watermark at the bottom of the document (15) and over this watermark, the book content (3).

### 8. CONCLUSION

It is verified for all that was described that this report is about the Personalized Printing Technique of Any Book or Content, With the Identification of the Reader and the Publishing Company, (1) which respects the regulations and norms for Invention Patent,

and will certainly fulfil important existing gaps in the market, specially for offering all the advantages described in this report.

1) “Personalized Printing Technique of Any Book or Content, With the Identification of the Reader and the Publishing Company”, (1) constituted by printing (2) some content (3) of a book or digital media, overlapped to the registered data (4) from the user (5), computer's IP address from where the reader accesses the system, date, hour (6), publishing company's logo and/or other items (7) in undertone, which is characterized as being constituted by a system to create printing in a simultaneous way.

2) “Personalized Printing Technique of Any Book or Content, With the Identification of the Reader and the Publishing Company”, (1) characterized according to the claim of number one because the user (5), via internet (8), accesses the system by a covenant and/or directly (9) in addition to his/her registered data (4), which are identified with the name, identity registration number, social security number (or other ID), computer's IP address from where the reader accesses the system, date, hour (6), which are stored in a database (10) in order to formalize the printing requisition (11) of the content (3) from a book or digital media.

3) Personalized Printing Technique of Any Book or Content, With the Identification of the Reader and the Publishing Company”, (1) characterized according to the claim of number two because the content (3) from books or from a digitalized media, stored in a proper database (12) is loaded in a page (13) in the system's memory, and at the same time, the database (10), with the registered data (4) from the user (5) and the others (publishing company and computer), transcribes the data in another page (14) in the system's memory so that in the sequence, they are to be merged through a programme, “software”, integrating then the content (3) with the registered data (4) in undertone, to result, in one sole stage, a unique document (15), with the personal data from the user (5) and others (publishing company and computer) in undertone like a watermark at the bottom of the document (15) and over this watermark, the book content (3).
